(19) United States
(12) Patent Application Publication
(10) Pub. No.: US 2026/0046135 A1
(43) Pub. Date: Feb. 12, 2026

(54) SECONDARY AUTHENTICATION FOR CONTROLLER PASSWORD SETTINGS AND REKEY IN REMOTE MSED ENCRYPTION CONFIGURATION

(71) Applicant: Microchip Technology Incorporated, Chandler, AZ (US)

(72) Inventor: Varun L. Chowdary, Chittoor (IN)

(73) Assignee: Microchip Technology Incorporated, Chandler, AZ (US)

(21) Appl. No.: 18/898,778

(22) Filed: Sep. 27, 2024

(30) Foreign Application Priority Data
Aug. 12, 2024 (IN) 202411061054

(51) Int. Cl. H04L 9/32; H04L 9/08

(52) U.S. Cl. CPC H04L 9/3226; H04L 9/0891

(57) ABSTRACT

A method comprising: enabling a secondary authentication password via a controller during remote managed self-encrypting drive encryption; storing the secondary authentication credential in a memory of the controller; and allowing a change of remote managed self-encrypting drive settings when authentication via the secondary authentication credential is successful. A device comprising: a memory to store the secondary authentication credential; and a controller to: enable a secondary authentication credential during remote managed self-encrypting drive encryption; and allow a change of remote managed self-encrypting drive settings when authentication via the secondary authentication credential is successful.

### RELATED APPLICATIONS

This application claims the benefit of IN patent application No. 202411061054 filed Aug. 12, 2024, which is incorporated herein in its entirety.

### TECHNICAL FIELD

The present disclosure relates to managed self-encrypting drive (MSED) encryption, in particular, remote MSED encryption where a master key is not exposed to user as it is encrypted and stored in a remote key manager service (KMS) server.

### BACKGROUND

In local managed self-encrypting drive (MSED) encryption for any settings related to controller password or changing master key or master key identifier, users provide current master key as input for authentication. In remote MSED encryption, master key is not exposed to user as it is encrypted and stored in a remote key manager service (KMS) server.

In case of key management service (KMS) inactive, when a user enters the controller password and unlocks a controller, the master key is wrapped inside the controller password in non-volatile random access memory (NVRAM) may be used to unlock all encrypted logical volumes or drives.

In remote MSED encryption mode, there is no authentication for controller password enable/disable or to change the controller password. Anyone can change the controller password, or anyone can disable/enable the controller password or anyone can initiate a rekey on controller. After enabling remote managed self-encrypting drive (MSED) encryption on a controller, users are allowed to set/change/disable controller password, rekey and allow operations related to controller password directly without any authentication.

A system may be configured with remote MSED encryption and secured logical volumes may be created. If an intruder has access to the system credentials, the intruder can login and set a controller password if not set already or change controller password if already set, and the intruder may steal server or the controller with drives attached. Once the intruder takes the controller and drives or complete server, even though the KMS is not active and master key is not available after power on of server, the intruder can unlock the controller (as KMS will be in inactive state) and access all the secured data. By providing the controller password settings (enable/disable/change) without any authentication, a potential security issue for data theft is allowed. For example, when User A has set a controller password in remote MSED encryption mode, then in case of key manager server failure or inaccessibility, the User A will provide the controller password he has set during enablement and unlock encrypted logical volumes or drives. But as there is no secondary authentication, anyone can change/disable the controller password. If an intruder or anyone with access to system can easily disable/change/set controller password, then user a cannot access the data which is locked when the key manager server is not accessible.

There is a need for security in remote managed self-encrypting drive (MSED) encryption for any settings related to controller password or changing master key or master key identifier.

### SUMMARY OF THE INVENTION

According to an aspect, there is provided a method comprising: providing a self-encrypting drive; providing a self-encrypting drive controller, on a remote key manager service server, in remote communication with the self-encrypting drive; enabling the self-encrypting drive controller to allow access to data stored on the self-encrypting drive when authentication via a first level credential is successful; and enabling the self-encrypting drive controller to allow configuration changes of the self-encrypting drive controller when authentication via a second level credential is successful.

An aspect provides a method as in the preceding paragraph, wherein the first level credential comprises a master key.

An aspect provides a method as in one of the preceding two paragraphs, wherein the second level credential comprises a password.

An aspect provides a method as in one of the preceding three paragraphs, wherein successful authentication via the second level credential allows the second level credential to be set, changed, or disabled.

An aspect provides a method as in one of the preceding four paragraphs, wherein successful authentication via the first level credential and successful authentication via the second level credential allows the first level credential to be set, changed, or disabled.

An aspect provides a method as in one of the preceding five paragraphs, wherein satisfaction of the first level credential and the second level credential allows access to data stored on the self-encrypting drive.

An aspect provides a method as in one of the preceding six paragraphs, comprising storing the second level credential in non-volatile random access memory of the remote key manager service server.

An aspect provides a method as in one of the preceding seven paragraphs, wherein configuration changes of the self-encrypting drive controller comprise configuration changes in firmware.

According to an aspect, there is provided a device comprising: a self-encrypting drive controller for remote control of a self-encrypting drive; a first level credential circuit to allow access to data stored on the self-encrypting drive when authentication via a first level credential is successful; and a second level credential circuit to allow configuration changes of the self-encrypting drive controller when authentication via a second level credential is successful.

An aspect provides a device as in the preceding paragraph, wherein the self-encrypting drive controller comprises the first level credential circuit and the second level credential circuit.

An aspect provides a device as in one of the preceding two paragraphs, wherein the first level credential comprises a master key.

An aspect provides a device as in one of the preceding three paragraphs, wherein the second level credential comprises a password.

An aspect provides a device as in one of the preceding four paragraphs, wherein second level credential circuit is to allow the second level credential to be set, changed, or disabled upon successful authentication via the second level credential.

An aspect provides a device as in one of the preceding five paragraphs, wherein the first level credential circuit and the second level credential circuit are to allow the first level credential to be set, changed, or disabled upon successful authentication via the first level credential and successful authentication via the second level credential.

An aspect provides a device as in one of the preceding six paragraphs, wherein the first level credential circuit and the second level credential circuit are to allow access to data stored on the self-encrypting drive upon successful authentication via the first level credential and successful authentication via the second level credential.

According to an aspect, there is provided a system comprising: a self-encrypting drive; a remote key manager service server comprising a self-encrypting drive controller for remote control of the self-encrypting drive; a first level credential circuit to allow access to data stored on the self-encrypting drive when authentication via a first level credential is successful; and a second level credential circuit to allow configuration changes of the self-encrypting drive controller when authentication via a second level credential is successful.

An aspect provides a system as in the preceding paragraph, wherein the second level credential is stored in a non-volatile random access memory of the remote key manager service server.

An aspect provides a system as in one of the preceding two paragraphs, wherein configuration changes of the self-encrypting drive controller comprise configuration changes in firmware of the remote key manager service server.

An aspect provides a system as in one of the preceding three paragraphs, wherein second level credential circuit is to allow the second level credential to be set, changed, or disabled upon successful authentication via the second level credential.

An aspect provides a system as in one of the preceding four paragraphs, wherein the first level credential circuit and the second level credential circuit are to allow access to data stored on the self-encrypting drive upon successful authentication via the first level credential and successful authentication via the second level credential.

### BRIEF DESCRIPTION OF THE DRAWINGS

The figures illustrate examples of remote managed self-encrypting drive (MSED) encryption configuration (logical volumes/drives) on redundant array of independent disks/host bus adapter (RAID/HBA) controllers.

FIG. 1 shows a flowchart for a vulnerable remote MSED encryption configuration.

FIG. 2 shows a flowchart for enabling a secondary authentication password during remote MSED encryption.

FIG. 3 provides a flow chart of vulnerable communications between a remote key manager service (KMS) server, a unified extensible firmware interface (UEFI) driver, controller firmware, and a configuration utility of user tools.

FIG. 4 provides a flow chart of secure communications between a remote key manager service (KMS) server, a unified extensible firmware interface (UEFI) driver, controller firmware, and a configuration utility of user tools.

FIG. 5 shows a flow chart of a method for enabling first and second level authentication via remote key manager service server in communication with a self-encrypting drive.

FIG. 6 shows a block diagram of a device for enabling first and second level authentication via remote key manager service server in communication with a self-encrypting drive.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect, there is provided security in local managed self-encrypting drive (MSED) encryption for any settings related to controller password or changing master key or master key identifier.

Where a remote MSED encryption may be more secured than local MSED encryption as the master key is stored in a key manager server, a remote MSED settings change on the controller may not be allowed without a secondary authentication.

A controller may have an option to enable a secondary authentication password during remote MSED encryption to enable and store the password in controller NVRAM and allow a change of remote MSED settings (controller password set/disable/change & rekey) upon successful authentication. By implementing a secondary authentication, loopholes to bypass security may be precluded and data may be secured.

By enabling a secondary authentication for configuration changes in remote MSED Encryption settings we restrict configuration changes without authentication and prevent a possible chance of data theft. A secondary authentication password may be stored in a controller NVRAM, same as a controller password storing mechanism, and allow the configuration changes for remote MSED encryption in firmware if the secondary authentication is successful.

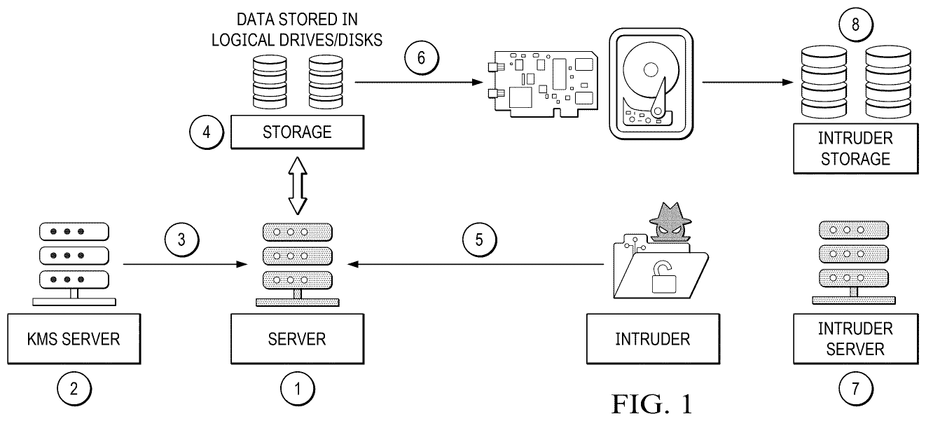

FIG. 1 shows a flowchart for a vulnerable remote MSED encryption configuration. (1) A server with a MCHP controller with remote MSED encryption is managed. (2) A master key may be created and stored during remote MSED enable. (3) A master key stored in a KMS server is retrieved to the controller if a connection is active. (4) Data is accessible if KMS is active and master key is fetched from KMS. (5) If an intruder is able to break the first level of the basic system credentials, the intruder can set/change/disable a controller password for remote MSED configuration. (6) If a controller password is set/changed by an intruder, the intruder may take the controller and attached drives. (7) If a legitimate user connects the controller and drives to the intruder's server, the controller will be in locked state and the intruder can provide the controller password, which the intruder set before stealing the card and drives, and unlock all the secured data. (8) A controller password will have a master key wrapped inside of the controller password.

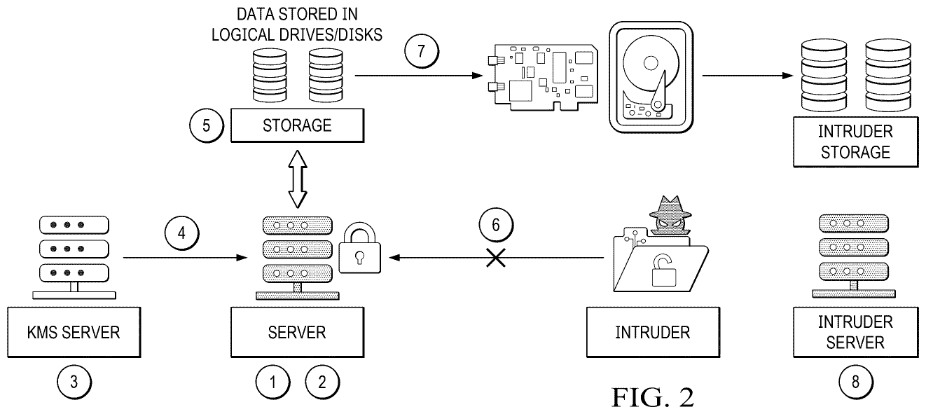

FIG. 2 shows a flowchart for enabling a secondary authentication password during remote MSED encryption. (1) A server with a MCHP controller where remote MSED encryption is managed. (2) A secondary authentication password is set for set/change/disable controller password. (3) A master key will be created and stored during remote MSED enable. (4) A master key stored in KMS server is retrieved to controller if a connection is active. (5) Data is accessible if KMS is active and master key is fetched from KMS or after unlocking controller password if KMS is in active. (6) If an intruder is able to break the first level of the basic system credentials, the intruder cannot set/change/disable controller password for remote MSED configuration without providing a secondary key. (7) If controller password is set/changed by an intruder and the intruder takes away controller and drives attached. (8) Once user connects the controller and drives to the intruder server, the controller will be in a locked state and the intruder has to provide an existing controller password, which the intruder does not have.

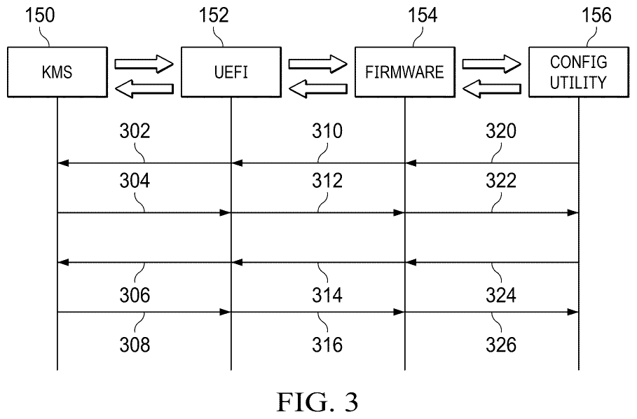

FIG. 3 provides a flow chart of vulnerable communications between a remote key manager service (KMS) server 150, a unified extensible firmware interface (UEFI) driver 152, controller firmware 154, and a configuration utility 156 of user tools. The UEFI driver 152 receives KMS action bit from controller firmware 154 and checks 302 if KMS service is active and if active. Controller firmware 154 partially enables remote MSED and sets 310 action bit to UEFI driver 152 to make communication with KMS manager server 150 for master key creation. The remote MSED encryption enables 320. The KMS manager server 150 will create a master key and it will be associated with key identifier and sent 304 to UEFI driver 152. The controller firmware 154 will receive the master key and key ID from UEFI driver 152 and store 312 in controller volatile memory. Tools will be updated with key ID and remote MSED will be enabled 322. UEFI driver 152 will query 306 KMS manager server 150 for KMS status. Controller firmware 154 will set/change/disable controller password and store 314 master key within controller password by wrapping key. Set/Disable/Change Controller password and rekey (new master key creation) 324. If KMS service status is not available 308, then UEFI driver 152 will set 316 KMS info (not available) in controller firmware 154. Controller firmware 154 will go to locked state (encrypted logical volumes/drives will be locked) and user tools of the configuration utility 156 will display 326 option to unlock controller password.

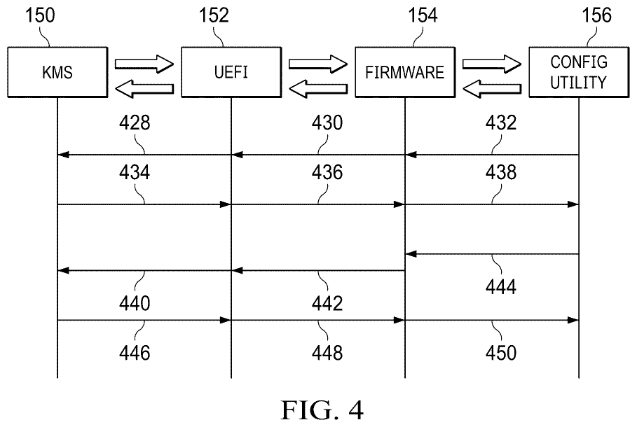

FIG. 4 provides a flow chart of secure communications between a remote key manager service (KMS) server 150, a unified extensible firmware interface (UEFI) driver 152, controller firmware 154, and a configuration utility 156 of user tools. The UEFI driver 152 receives 428 KMS action bit from controller firmware 154 and checks if KMS service is active and If active. The controller firmware 154 partially enables remote MSED and sets 430 action bit to UEFI driver 152 to make communication with KMS 150 for master key creation. Controller firmware 154 will store 430 the secondary authentication password in controller NVRAM. Remote MSED encryption is enabled to set 432 a secondary authentication. KMS 150 will create 434 a master key and it will be associated with a key identifier and sent to UEFI driver 152. Controller firmware 154 will receive 436 the master key and key ID from UEFI driver 152 and store in controller volatile memory. User tools of the configuration utility 156 will be updated with key ID and remote MSED will be enabled 438. The UEFI driver 152 will query 440 the KMS server 150 for KMS status. Controller firmware 154 will first check if the secondary authentication is correct, and if correct, then proceed to update 442 changes as to set/change/disable controller password and store master key within controller password by wrapping key. The configuration utility 156 provides 444 set/disable/change Controller password and rekey (new master key creation), and confirms secondary authentication password. If the KMS 150 indicates 446 the KMS service status is not available, the UFEI driver 152 with set 448 KMS info (not available) in the controller firmware 154. The controller firmware 154 will go 450 to locked state (encrypted logical volumes/drives will be locked) and tools will display option to unlock controller password.

According to an aspect, there is provided an algorithm for communications between a remote key manager service (KMS) server 150, a unified extensible firmware interface (UEFI) driver 152, controller firmware 154, and a configuration utility 156 of user tools.

### Pseudocode_part_1:

```
  if ENCRYPTION_MODE_IS_REMOTE
    SET_SECONDARY_AUTHENTICATION_PASSWORD
    if SECONDARY_AUTHENTICATION_PASSWORD_IS_SET
      ALLOW_FW_TO_ENABLE_REMOTE_MSED_ENCRYPTION
display REMOTE_MSED_ENCRYPTION_ENABLE_SUCCESS
  If USER_REQUESTED_CONTROLLER_PASSWORD_SET
    ENETER_NEW_CONTROLLER_PASSWORD
    if USER_ENTERED_CONTROLLER_PASSWORD_MATCHES
      CRITERIA_FOR PASSWORD
    PROCEED_TO_NEXT_STEPS
    ENTER_SECONDARY_AUTHENTICATION_PASSWORD
    if SECONDARY_AUTHENTICATION_IS_SUCCESS
      ALLOW_SETTING_OF CONTROLLER_PASSWORD
  display SETTING_CONTROLLER_PASSWORD_IS_SUCCESS
  If USER_REQUESTED_CONTROLLER_PASSWORD_CHANGE
    if USER_ENTERED_CONTROLLER_PASSWORD_MATCHES
      CRITERIA_FOR PASSWORD
    PROCEED_TO_NEXT_STEPS
    ENTER_SECONDARY_AUTHENTICATION_PASSWORD
    if SECONDARY_AUTHENTICATION_IS_SUCCESS ALLOW_CHANGE_OF
      CONTROLLER_PASSWORD
  display CHANGE_CONTROLLER_PASSWORD_IS_SUCCESS
```

### Pseudocode_part_2:

```
If USER_REQUESTED_CONTROLLER_PASSWORD_DISABLE
    PROCEED_TO_NEXT_STEPS
  ENTER_SECONDARY_AUTHENTICATION_PASSWORD
  if SECONDARY_AUTHENTICATION_IS_SUCCESS ALLOW_DISABLE_OF
      CONTROLLER_PASSWORD
display DISABLE_CONTROLLER_PASSWORD_IS_SUCCESS
If USER_REQUESTED_CONTROLLER_REKEY PROCEED_TO_NEXT_STEPS
  ENTER_SECONDARY_AUTHENTICATION_PASSWORD
  if SECONDARY_AUTHENTICATION_IS_SUCCESS
      ALLOW_REKEY_OF CONTROLLER_MASTERKEY
display CONTROLLER_REKEY_IS_SUCCESS
If USER_REQUESTED_SEONDARY_AUTHENTICATION_PASSWORD_CHANGE
  if USER_ENTERED_ SEONDARY_AUTHENTICATION
      _PASSWORD_MATCHES CRITERIA_FOR PASSWORD
      PROCEED_TO_NEXT_STEPS
  ENTER_CURRENT_SECONDARY_AUTHENTICATION_PASSWORD
  if SECONDARY_AUTHENTICATION_IS_SUCCESS ALLOW_CHANGE_OF
      SEONDARY_AUTHENTICATION _PASSWORD
display CHANGE_ SEONDARY_AUTHENTICATION _PASSWORD_IS_SUCCESS
```

An aspect provides a design solution for security in remote MSED encryption for secured drives/logical volumes and configuration in MCHP storage controllers. An aspect adds a secondary authentication in remote MSED encryption to prevent an unauthorized change of controller password settings and rekey.

Secondary authentication credentials may include: identifier/password; assigned authentication characters; biometric information, such as iris, fingerprint, or voice; and a generated random number. Secondary authentication credentials may include two-factor authentication. Credentials are not limited to any particular type of credential, and in various aspects include any credentials, such as a PIN, a one-time password, a biometric, hardware password, software password, or any other credential usable to gate the requested access, without limitation. By way of further illustration, for credentials including one-time passwords, the user again supplies his user ID when prompted but then using a hardware or software password token that is in their possession, generates a one-time (single use) password and enters that when prompted. The one-time password is generated based on a secret key that is securely stored in both the token and the gating authentication server database. When the gating authentication server receives the user ID and one-time password, it looks up the user ID in a database along with the user's secret key. The gating authentication server then generates the expected one-time password and compares it to the supplied one-time password. If the passwords match the user is considered to have passed authentication. There are several modes of operation available with tokens and one-time passwords that may include additional PINs and challenge/response sequences, and aspects are not limited to any particular mode of operation that include tokens and one-time passwords.

Using layered security and multiple factors of authentication may provide enhanced security for the secondary authentication credentials. Strong authentication (via multi-factor authentication) refers to authentication that uses at least two or more factors, where those factors are of different types. An authentication factor represents some piece of data or attribute that can be used to authenticate a user requesting access via that secondary authentication credentials. The main authentication factors are knowledge, possession and inherence. Knowledge factors include all things a user knows in order to log in via the secondary authentication credentials, including user names, passwords, personal identification numbers (PINs), personal-related information specific to the user, such as mother's maiden name, first pet name, place of honeymoon, or other responses, for example. Possession factors consist of anything a user has in their possession in order to log in via the secondary authentication credentials, which may include one-time password tokens as key fobs or smartphone apps, employee ID cards and SIM card-based mobile phones. Inherence factors may include any inherent traits the user has that are confirmed for login via the secondary authentication credentials, such as biometrics (retina scans, iris scans, fingerprint scans, finger vein scans, facial recognition, voice recognition, hand geometry, and earlobe geometry, without limitation).

Using two-factor authentication, a user provides a knowledge factor (user ID and password) combined with a second authentication factor, either a possession factor or an inherence factor. For instance, via a two-factor authentication technique the user demonstrates possession of something, such as a smart phone, in addition to their user ID and password, where the user may enter a verification code received via text message on a preregistered mobile phone, or a code generated by an authentication application. Three-factor authentication uses three authentication factors, usually a knowledge factor (password) combined with a possession factor (security token) and inherence factor (biometric). Systems that call for those three factors (knowledge, possession, and inherence) plus a location (geographic) or a time factor are considered examples of four-factor authentication. According to aspects, these forms of authentication may be used to gate access via the secondary authentication credentials.

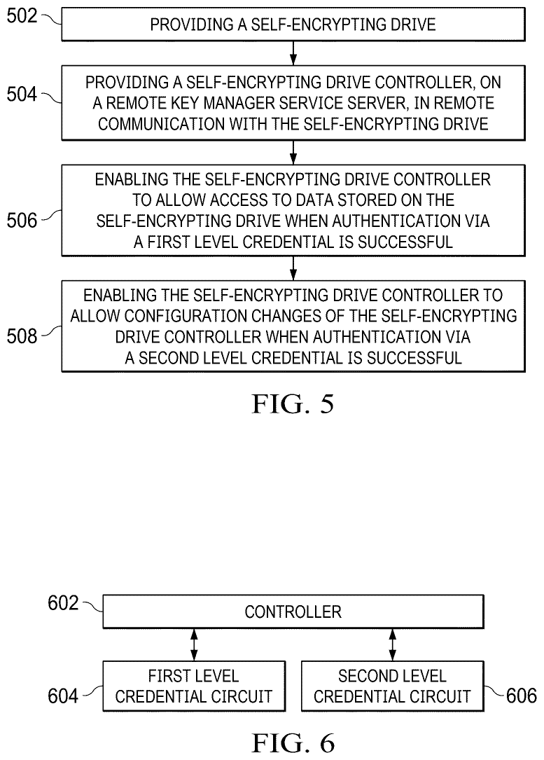

FIG. 5 shows a flow chart of a method. A self-encrypting drive is provided 502. A self-encrypting drive controller is provided 504, on a remote key manager service server, in remote communication with the self-encrypting drive. The self-encrypting drive controller is enabled 506 to allow access to data stored on the self-encrypting drive when authentication via a first level credential is successful. The self-encrypting drive controller is enabled 508 to allow configuration changes of the self-encrypting drive controller when authentication via a second level credential is successful.

FIG. 6 shows a block diagram of a device. The device has a self-encrypting drive controller 602 for remote control of a self-encrypting drive. The device has a first level credential circuit 604 to allow access to data stored on the self-encrypting drive when authentication via a first level credential is successful. The device also has a second level credential circuit 606 to allow configuration changes of the self-encrypting drive controller when authentication via a second level credential is successful.

Although examples have been described above, other variations and examples may be made from this disclosure without departing from the spirit and scope of these disclosed examples.

1. A method comprising:
providing a self-encrypting drive;
providing a self-encrypting drive controller, on a remote key manager service server, in remote communication with the self-encrypting drive;
enabling the self-encrypting drive controller to allow access to data stored on the self-encrypting drive when authentication via a first level credential is successful; and
enabling the self-encrypting drive controller to allow configuration changes of the self-encrypting drive controller when authentication via a second level credential is successful.

2. The method as in claim 1, wherein the first level credential comprises a master key.

3. The method as in claim 1, wherein the second level credential comprises a password.

4. The method as in claim 1, wherein successful authentication via the second level credential allows the second level credential to be set, changed, or disabled.

5. The method as in claim 1, wherein successful authentication via the first level credential and successful authentication via the second level credential allows the first level credential to be set, changed, or disabled.

6. The method as in claim 1, wherein satisfaction of the first level credential and the second level credential allows access to data stored on the self-encrypting drive.

7. The method as in claim 1, comprising storing the second level credential in non-volatile random access memory of the remote key manager service server.

8. The method as in claim 1, wherein configuration changes of the self-encrypting drive controller comprise configuration changes in firmware.

9. A device comprising:
a self-encrypting drive controller for remote control of a self-encrypting drive;
a first level credential circuit to allow access to data stored on the self-encrypting drive when authentication via a first level credential is successful; and
a second level credential circuit to allow configuration changes of the self-encrypting drive controller when authentication via a second level credential is successful.

10. The device of claim 9, wherein the self-encrypting drive controller comprises the first level credential circuit and the second level credential circuit.

11. The device as in claim 9, wherein the first level credential comprises a master key.

12. The device as in claim 9, wherein the second level credential comprises a password.

13. The device as in claim 9, wherein second level credential circuit is to allow the second level credential to be set, changed, or disabled upon successful authentication via the second level credential.

14. The device as in claim 9, wherein the first level credential circuit and the second level credential circuit are to allow the first level credential to be set, changed, or disabled upon successful authentication via the first level credential and successful authentication via the second level credential.

15. The device as in claim 9, wherein the first level credential circuit and the second level credential circuit are to allow access to data stored on the self-encrypting drive upon successful authentication via the first level credential and successful authentication via the second level credential.

16. A system comprising:
a self-encrypting drive;
a remote key manager service server comprising a self-encrypting drive controller for remote control of the self-encrypting drive;
a first level credential circuit to allow access to data stored on the self-encrypting drive when authentication via a first level credential is successful; and
a second level credential circuit to allow configuration changes of the self-encrypting drive controller when authentication via a second level credential is successful.

17. The system as in claim 16, wherein the second level credential is stored in a non-volatile random access memory of the remote key manager service server.

18. The system as in claim 16, wherein configuration changes of the self-encrypting drive controller comprise configuration changes in firmware of the remote key manager service server.

19. The system as in claim 16, wherein second level credential circuit is to allow the second level credential to be set, changed, or disabled upon successful authentication via the second level credential.

20. The system as in claim 16, wherein the first level credential circuit and the second level credential circuit are to allow access to data stored on the self-encrypting drive upon successful authentication via the first level credential and successful authentication via the second level credential.
